(19) United States
(12) Patent Application Publication
(10) Pub. No.: US 2015/0205675 A1
(43) Pub. Date: Jul. 23, 2015

(54) Method and System for Improving Reliability of a Background Page

(71) Applicants: Matthew BOLOHAN, Waterloo (CA); Theodora Yeung, Seattle, WA (US)

(72) Inventors: Matthew BOLOHAN, Waterloo (CA); Theodora Yeung, Seattle, WA (US)

(73) Assignee: Google Inc., Mountain view, CA (US)

(21) Appl. No.: 13/449,093

(22) Filed: Apr. 17, 2012

(51) Int. Cl. G06F 17/00; H04L 29/08

(52) U.S. Cl. CPC G06F 11/1438; H04L 67/02; G06F 2201/805; G06F 2201/875

(57) ABSTRACT

Methods, systems, and techniques for monitoring a background page are described herein. An example method includes running a web application and loading, in a browser, a background page that performs one or more actions for the web application. The background page may be hidden from a user. The method further includes loading, in the background page, one or more window objects containing business logic of the web application. The window objects may be hidden from the user and may execute business logic of the web application. The method also includes monitoring a status of the one or more window objects and determining a status of the one or more window objects based on the monitoring. The method further includes when a status of a window object indicates a failure in the window object, shutting down the window object.

### FIELD

Embodiments generally relate to background pages of a web application.

### BACKGROUND

A background page provides additional functionality for a web application. Background pages can be less reliable, however, than traditional application pages for a number of reasons. For example, background pages typically run for long periods of time. Accordingly, a web application error may result in partial or total failure until the background page is restarted after a browser or machine restart. A long standing failure may be particularly harmful for applications that are constantly syncing data.

Background pages may also be less reliable than traditional application pages because background pages may be restricted to one instance per application. For example, multiple instances of an application may have only one background page.

Accordingly, the impact of a failure may increase as more responsibility is given to the background page. Another reason that background pages may be less reliable than traditional application pages may be because background pages are typically invisible to a user. Accordingly, a failure may be undetected indefinitely.

Examples of errors that may occur in the background page are script errors, database or storage errors, authentication failures, and unexpected redirects. Errors occurring in the background page may cause application failure.

### BRIEF SUMMARY

Embodiments relate to monitoring a background page. An example method includes running a web application. The exemplary method also includes loading, in a browser, a background page that performs one or more actions for the web application. The background page may be hidden from a user. The method further includes loading, in the background page, one or more window objects containing business logic of the web application. The one or more window objects may be hidden from the user and may execute business logic of the web application. The method also includes monitoring a status of one or more window objects. The method further includes determining a status of one or more window objects based on the monitoring. The method also includes when a status of a window object indicates a failure in the window object, shutting down the window object. In one feature, the failure in the window object does not result in a failure of the web application.

Other embodiments of these aspects include corresponding systems, apparatuses, and computer program products configured to perform the actions of these methods, encoded on computer storage devices.

Further features and advantages of embodiments described herein, as well as the structure and operation of various embodiments, are described in detail below with reference to the accompanying drawings. It is noted that the embodiments described below are not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS/FIGURES

Embodiments are described with reference to the accompanying drawings. The accompanying drawings, which are incorporated herein and form a part of the specification, illustrate embodiments and, together with the description, further serve to explain the principles of the embodiments and to enable a person skilled in the relevant art to make and use the embodiments. In the drawings, like reference numbers may indicate identical or functionally similar elements. The drawing in which an element first appears is generally indicated by the left-most digit in the corresponding reference number.

FIG. 1 is a block diagram of a distributed system in which embodiments may be implemented.

FIG. 2 is a flowchart illustrating a method for monitoring a background page, according to an embodiment.

FIG. 3 illustrates an example computer system in which embodiments may be implemented as computer-readable code.

### DETAILED DESCRIPTION

### I. Overview

### II. System Environment

### III. Access Window Objects in the Background Page

A. Background Page

B. Application Page

### IV. Health Monitoring

A. Existence of Function

B. Return Value of Function

C. Other Monitoring Techniques

### V. Constraints

### VI. Method

### VII. Computer Embodiment

I. Overview

This disclosure describes techniques that increase the reliability of a background page. The complexity of the background page may be reduced while maintaining the same level of functionality.

The health of a background page may be monitored to ensure that it is healthy. A background page may be considered healthy if there are no errors in the background page. A background page works in the background and may carry out functions typically performed by the application. An error in the background page may be hard to detect and lead to an application failure. As such, it may be useful to isolate the occurrence of background page errors such that a background page failure does not result in an application failure.

Business logic of the application may be separated from the logic that monitors the background page for errors. A user requested application page may spawn a background page, and in turn the background page may spawn one or more window objects. A script running in the window object may execute business logic of the application. Executing business logic may include executing a script that is running in the context of the application. The background page may execute non-business logic. Executing non-business logic may include executing a script related to monitoring the health of the window objects. For example, executing non-business logic may include executing scripts related to creating and destroying window objects and querying the health of the window objects in the background page.

In an embodiment, a background page that performs one or more actions for a web application is loaded in a browser. The background page may be hidden from the user. One or more window objects containing business logic of the web application is loaded in the background page. The one or more window objects may be hidden from the user and may execute business logic of the web application. A status of the one or more window objects is monitored, and the status of the one or more window objects may be determined based on the monitoring. When a status of a window object indicates a failure in the window object, the window object is shut down. In one feature, a failure in a window object does not result in a failure of the web application.

While the present embodiments are described herein with reference to illustrative embodiments for particular applications, it should be understood that the disclosure is not limited thereto. Those skilled in the art with access to the teachings provided herein will recognize additional modifications, applications, and embodiments within the scope thereof and additional fields in which the embodiments would be of significant utility.

II. System Environment

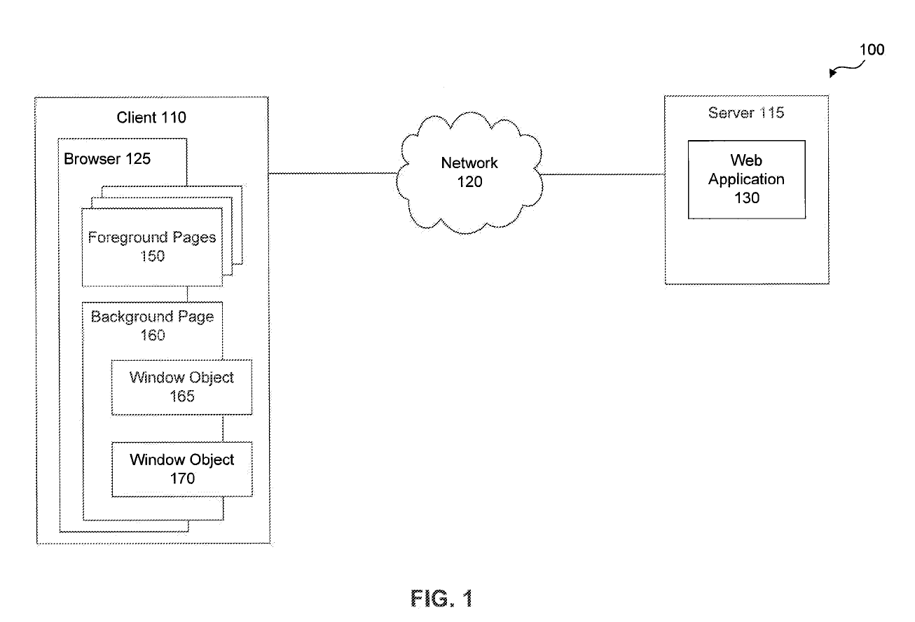

FIG. 1 is a block diagram of a distributed system 100 in which embodiments may be implemented.

System 100 includes a client 110 that is communicatively coupled to a server 115 via a network 120. Client 110 can be any computing device. Examples of computing devices include, but are not limited to, a central processing unit, an application-specific integrated circuit, a computer, workstation, distributed computing system, computer cluster, embedded system, stand-alone electronic device, networked device, mobile device (e.g., mobile phone, smart phone, personal digital assistant (PDA), navigation device, tablet, or mobile computing device), rack server, set-top box, or other type of computer system having at least one processor and memory. A computing process performed by a clustered computing environment or server farm may be carried out across multiple processors located at the same or different locations. Such a computing device may include software, firmware, hardware, or a combination thereof. Software may include one or more applications and an operating system. Hardware may include, but is not limited to, a processor, memory, and user interface display.

Server 115 can be implemented using any computing device capable of serving data to the client. Server 115 can be, for example, and without limitation, a telecommunications server, a web server, or other type of database server. As illustrative examples, the web server may be, without limitation, Apache HTTP Server, Apache Tomcat, Microsoft Internet Information Server, JBoss Application Server, WebLogic Application Server, or Sun Java System Web Server. The web server may serve content such as hypertext markup language (HTML), extendable markup language (XML), documents, videos, images, multimedia features, or any combination thereof. This example is strictly illustrative and does not limit the scope of the present disclosure.

Network 120 can be any network or combination of networks that can carry data communication, and may be referred to herein as a computer network. Such network 120 can include, but is not limited to, a wired (e.g., Ethernet) or a wireless (e.g., Wi-Fi and 3G).network, a local area network, medium area network, and/or wide area network such as the Internet. Network 120 can support protocols and technology including, but not limited to, World Wide Web protocols and/or services. Intermediate web servers, gateways, or other servers may be provided between components of system 100 depending upon a particular application or environment.

Client 110 includes a browser 125. A browser is a software application that allows a user to view or download content that is available on a network, such as on a website or web application on the World Wide Web. Content may include text, files, images, audio, video and personal communications. A web page presents such content and is located using a uniform resource identifier (URI) such as a uniform resource locator (URL). A web page may be retrieved using the Internet Protocol (IP) address of the computer holding the web page content. A browser may use a number of protocols and standards to obtain or manage content flow. For example, a browser may use hypertext transfer protocol (HTTP) to fetch content and web pages. HTTP is an application-level protocol providing basic request/response semantics. For example, server 115 may package the generated content and serve the content to client 110 in the form of an HTTP response. A server may be a software component that responds to an HTTP request with an HTITP reply.

System 100 may include more or fewer than the components shown in FIG. 1. For example, server 115 may include more than one web application.

Server 115 includes a web application 130 that generates content in response to a request (e.g., an HTTP request). Browser 125 requests resources from web application 130 over network 120. For example, browser 125 may request one or more foreground pages 150 from web application 130. Foreground page 150 may be a user-visible application page with which the user may interact.

In embodiments, web application 130 can operate on server 115, on browser 125, or have its functionality distributed between server 115 and browser 125 depending upon a particular application.

In an embodiment, foreground page 150 spawns a background page 160. In another embodiment, when the browser starts and independent from the web application, background page 160 is started automatically. A background page may be a “hidden” page that is launched by the application and may not be easily apparent to the user. The background page may perform one or more actions for the web application. One or more foreground pages may be associated with a background page.

An application may be associated with two or more background page instances with only one background page running at any one time. To switch background pages, a background page may be redirected to a different URL adhering to the same restrictions as the previous background page.

Further, a background page may be split into different pages that are responsible for different states. For example, a web application may have one parent background page that monitors the state of the window objects. A first background page may be used for authenticated users and a second background page may be used for unauthenticated users, and the running background page may toggle between the two states.

In an embodiment, background page 160 spawns window objects 165 and 170. A background page may be associated with one or more window objects. A window object may be used to embed a document within a parent document (e.g., an HTML document). The window object may “box” a script such that it is prevented from causing problems to the main page in case of script failure. For example, if a script or redirect failure occurs, the script executing in the window object may fail without affecting the main page.

Window objects may enable a browser window to be split into segments and each window object in a web page may include a different document. Accordingly, each window object loaded in the background page may execute a different script that performs a different function. The window object may be injected into the document object model (DOM) of the background page to enable the window object to perform various actions.

The background page may load a window object that contains and executes business logic of the web application in the background. The window object lives in the background page and may not be easily apparent to the user (e.g., hidden from the user).

In an embodiment, background page 160 monitors cookies and spawns window objects when a condition is satisfied. In an example, the condition is satisfied when a user logs in to application 130. Accordingly, background page 160 may launch a window object for each logged-in user. In another example, different URLs are specified based on different users, and the different URLs may serve different scripts. In this example, when a new user logs in, different I-frames having different URLs are created for different users.

In an embodiment, browser 125 supports a file in which a background URL is specified for application 130. When browser 125 requests a web page from web application 130, browser 125 launches background page 160 and loads the background page with the specified URL. In an example, if browser 125 navigates to the specified background URL, a blank background page appears with one or more blank window objects. As such, the user effectively sees an empty page.

In an embodiment, window object 165 is an I-frame that includes an I-frame page. An I-frame page is a page loaded in an I-frame by, for example, the background page. The background page may create a new I-frame and the source of the I-frame may be set to a script that executes business logic of the application.

A window object may be described as being an I-frame for simplicity of description in this disclosure; however, other web objects developed in the future that may be embedded in a web page including documents different from the parent document are also within the spirit and scope of the present disclosure.

III. Access Window Objects in the Background Page

A. Background Page

In an embodiment, the management of window objects is handled entirely by the background page. A script executing in the background page is responsible for doing a number of things that contributes to the complexity reduction of the background page.

In an embodiment, background page loader loads a background page that performs one or more actions for a web application. After the background page loads, it may load window objects containing the business logic of the application. For example, a background page may be associated with an e-mail application and coded to launch one or more I-frames to perform various actions such as synchronizing a user account or performing a cleanup process.

A window object may be dynamically loaded in the background page. In an example, the window object is loaded as a child node in the background page.

In an embodiment, the background page is hard-coded to recognize which window objects the background page needs to load for each piece of business logic.

In another embodiment, the background page exposes a mechanism to the foreground page to allow the foreground page to instruct the background page on what to load. In an example, the foreground page provides the background page with the exact URL to load in the window object. In another example, the foreground page provides the background page with enough information for the background page to construct the URL. In an example, if the same domain is used to host the background page and all business logic I-frames, the foreground page may provide the background page only with the path of an I-frame because the background page already knows the host (e.g., the same host in which the background page was loaded).

A monitor may monitor a status of one or more window objects and determine the status of a window object based on the monitoring. In an embodiment, the monitor may be a background page, and the background page may call a function defined by a window object script (more details below). If a condition is satisfied (e.g., the function does not exist or the function throws an error or returns false), this may indicate to the background page that a failing window object has been encountered and that the window object should be reloaded. Reloading the window object may include shutting down the window object and reloading it in the background page. This mechanism may enable the application to have a health monitor that is continuously running and is in a separate document from the business logic scripts and DOM.

B. Application Page

In an embodiment, the application directly accesses window objects residing in a background page. The background page may preserve the application script's ability to access the business logic script running in the background. The background page may, for example, expose I-frame window objects as properties on its own window to allow the application script to directly access the I-frames.

The background page may provide an interface for obtaining a handle on a window object residing in the background. In an example, a foreground page obtains a reference to the background page. Based on the reference, a script running in the foreground page may obtain a handle on the window object that is responsible for performing a particular action (e.g., e-mail synchronization). The background page may serve as a proxy to the business logic so that information (e.g., the synchronization state and health of the background page or last time of synchronization) can be queried by the foreground page.

In an example, a user instructs an e-mail application to perform a forced synchronization of his e-mail. The user may want to force a synchronization because the user is about to get on a plane and will not have Internet connection. The application page may request an I-frame that is responsible for synchronizing the user's account. In response to the request, the background page may call a function and return the I-frame that matches the user's request to the foreground page. An internal map may map the user's request to the appropriate I-frame. A function may be exposed on the I-frame and the application page may call the function for the particular user by obtaining a reference to the window in the I-frame through the background page. Based on the reference, the application page may obtain a handle on the I-frame and access it. In this way, the business logic may be separated because the application page and the I-frame page agree on an interface and the background page does not need to know how to execute the synchronization script.

In another example, if function GetLastTimeSync( ) were added, the background page would not need to know that this function was added. The foreground page may request the synchronization module window from the background page and then the foreground page may call any arbitrary function on that window object. Accordingly, the complexity of the background page may be reduced because the background page need only launch window objects, make sure they are healthy, and know what to do when they fail. It may be unnecessary for the background page to know how to execute the script running in the window object.

If the background page is responsible for synchronizing the current user and has only one window, the background page may return itself. In another example, if the background page launches one window object per user, a window object may be nested within another window object and the background page may return a different window object.

The browser may provide ways for the foreground page to obtain a reference to a window object in order to access it. For example, browser 125 may provide a function (e.g., window.open( )) that opens a URL to the web application. As such, the web application may use the function to open the URL and access the window object. In an example, the window object is added to the DOM of the background page and the web application accesses the window object via the DOM.

In an embodiment, the application is not able to directly access the window object in the background. The logic for managing I-frames may be an implementation detail of the background page. As such, it may be undesirable to expose this logic to the application pages.

IV. Health Monitoring

A monitor may monitor a status of a window object in the background page and determine the status of the window object based on the monitoring. The health monitoring of a background page may be implemented in various ways.

A. Existence of Function

In an embodiment, a script in the window object is expected to expose a function. When a script running in the window object exposes the expected function on its window, this may indicate to the background page that the script has successfully loaded. As such, determining the existence of the expected function may signal a successful load of the script running in the window object.

The function may be exposed by the application script or the business logic script running in the window object. In an example, a script running in a window object exposes a function IsHealthy( ) on its window. The script running in the background page may call the window object by invoking windowobject.Windows.IsHealthy( ) and the background page would expect that function to exist.

The non-existence of this function on the window object, however, may alert the background page that an error has occurred. Further, an error may have occurred before the script had a chance to expose that function on the window object. For example, if a user attempts to sign into an e-mail application and is not authenticated, the application may direct the user to an account login page. The account login page script will be different from the e-mail application script and these scripts may include different functions. Accordingly, if the function expected to be exposed in the e-mail application script does not exist when it is called by the background page, it may assume that the script has not loaded properly. Accordingly, the function is not exposed and the background page may determine that an error has occurred.

It may be useful to wait for a time period to elapse before invoking the function for the first time (e.g., the “onload” event is received from the window object). This may allow adequate time for a script to load properly if it is healthy.

B. Return Value of Function

If the expected function exists, it can be called. The expected function may return a value (e.g., Boolean value or number) that indicates a health status of the window object. The business logic running in the window object may decide whether or not the script is healthy based on implementation details. For example, if the window object experiences problems synchronizing e-mail because it cannot contact the network and this is considered to be unhealthy, then the expected function may return a false value.

A handshake may be used to indicate whether the script is executing successfully in the module. In an embodiment, the window object exposes a function (e.g., IsHealthy( )) to the background page, and the background page calls to the window object one or more times (e.g., periodically) to determine a status of the window object. Based on the return value of the function, the background page may determine whether the window object is healthy.

In another embodiment, the background page exposes a function to the window object, and after the window object has successfully loaded it invokes this function. Accordingly, the window object script may “call home” periodically to verify that it is still healthy. If the background page does not receive a call to this function after some time, the background page may consider the window object to have failed to load properly. If the background page receives a call to this function, the background page may consider the window object to have successfully loaded.

In another embodiment, the background page exposes a function to the foreground page. The function may enable the foreground page to query the health of the background page, and the application window may periodically check the background page to ensure that it is healthy and functioning properly. For example, the background page may implement functions that force a synchronization, request status information from the synchronization window object, and reload the window object if the foreground page determines that a failure has occurred. The foreground page may determine that a failure has occurred if, for example, a synchronization has not occurred within a timeframe (e.g., a couple of hours).

In another example, the background page exposes a function to allow an application script to check the health of the background page and reload if necessary (e.g., backgroundWindow.loadedSuccessfully( )). An application script may also call the function backgroundWindow.syncModuleWindow.forceSync( ) to access the business logic script running in the background to determine the health of the background page.

If the background page is functioning improperly, the background page may be reloaded. Upon detecting an error in the background page, it may be destroyed and recreated. In an embodiment, the browser or execution environment manages the reloading of failed background pages.

In another embodiment, the foreground page manages the reloading of failed background pages. In an example, the foreground page monitors the background page and when the foreground page detects that the background page is unhealthy, the foreground page destroys and recreates the background page. An exposed function may provide a mechanism for allowing the foreground page to check the health of the background page and restart it if necessary. In another example, if the foreground page determines that a failure has occurred, the foreground page instructs the background page to execute code to shut down and then reload the window object in the background page.

C. Other Monitoring Techniques

Other ways may be used to expose the health of the background page or window object. In an embodiment, a window object “pushes” a health status of the window object up to the background page (instead of exposing a function). The window object may send a message, set a property (e.g., variable), or manipulate a shared state (e.g., local storage) that signals a successful load of the script to the background page.

A first script may execute in the background page and a second script, different from the first script, may execute in a window object in the background page. In an example, the second script sends a message to the first script that indicates a status of the window object. The background page may monitor a status of the window object by analyzing the message.

In another example, the window object sets a variable that indicates a status of the window object. The status of the window object may be monitored by setting the variable to a particular value. For example, the window object may set the variable to a first value to signal a successful load of the script and may set the variable to a second value, different from the first value, to signal an unsuccessful load of the script. The background page may monitor a status of the window object by monitoring the variable.

In another example, the background page periodically refreshes the window object. The background page may reload or check whatever means it has to refresh the window object.

If a failure is detected, an amount of time that the background page waits before trying again may be based on a number of times the background page has detected a failure. For example, the background page may implement an exponential back-off strategy and wait a longer period of time before retrying. For instance, if the background page does not detect the expected function, the background page may wait one, two, four, eight seconds, and so on when a failure is detected. After a threshold number of failures is satisfied, the background page may reload the applicable window object.

V. Constraints

The background page may have several interesting constraints that reduce the complexity of the background page, risk of failing, risk of failing to load, or a combination of these. The background page may include one or a combination of the described constraints. The more constraints the background page has, the more robust the system may be.

For example, the background page may be served from a same domain as the application page. Browser 125 may include multiple processes, and each process may include one or more foreground pages running on a same domain. For example, domain mail.abc.com may have zero to many foreground pages, a single background page, and within the background page zero to many window objects that are also on mail.abc.com. Similarly, a different domain may have zero to many foreground pages, a single background page, and within the background page zero to many window objects that are also on that domain.

In another example, the background page may be served from a web server without redirects (e.g., 302 redirects). A script executing in the background page may monitor the window objects in the background page to ensure that they have not redirected to another page and also to ensure that the scripts running in the window objects are healthy. For example, the background page may call a function (e.g., IsHealthy( )) on the object window to obtain a status of the object window. In this way, the complexity of the background page may be reduced.

In another example, the background page may be served from a web server without requiring authentication. An application may load a background page to handle syncing a user's e-mail, which may be loaded from servers without requiring authentication. Upon loading, the background page may create an I-frame containing business logic to execute a page containing scripts to sync the user's e-mail, contacts, and other data. If the user is not authenticated, the sync page redirects to an accounts page. The background page may detect this redirect because the IsHealthy( ) function will not exist on the accounts page. The background page may correct this error by recreating the sync I-frame when the background page determines that the user might have valid credentials. If the synching stops due to an error (e.g., JavaScript or database error), a call to IsHealthy( ) may return a false value and the background page may recreate the I-frame. In this way, the complexity of the background page may be reduced.

In another example, the background page may load one or more window objects to contain all of the business logic and is not responsible for executing the scripts in the window objects. For example, the background page may have the functionality to load the window objects for different modules and the window object contains all of the business logic to execute the code. In this way, the complexity of the background page may be reduced.

In another example, the background page may contain a minimal amount of script. Separate scripts may implement the logic that persists in the background. Different design trade-offs may exist according to how scripts are designed. For performance reasons it may be desirable to send the minimal amount of code required to execute for a particular user depending on a context.

The background page may also load different window objects in the background page based on the different states (e.g., whether or not the user is online). In an example, the parent background page monitors a status pertaining to the user, such as whether credentials should be loaded for the user. A script running in the background may monitor for a user's credentials. If the script identifies a cookie for the user, the initial script may redirect to another script that takes over the monitoring and state detecting. This may be done for performance reasons, so that a smaller amount of script is loaded or when the script does not have work to perform. In this way, the more complex code may be loaded in the background page when a condition is met (e.g., credentials are discovered) or when the code is needed. If no credentials are present, it may be unnecessary for the background page to load the code for managing the window objects.

In another example, the background page may be cached independently in the application cache to minimize conflicts. An application cache is a set of cached resources including one or more resources identified by their respective URLs. The collection of resources may be obtained from a cache manifest file included in the web application. An application cache may support offline caching of a web application's resources. In an embodiment, the background page checks an application cache for updates periodically and reloads when new script is available. New script may be pushed for both the background page and the window objects running in the background page. The latest code may be requested from the application cache.

The background page may periodically refresh itself and destroy and restart. In another example, the background page may be restarted entirely once a week (or depending on how frequently the developer pushes new code). In another example, the background page may force a check for new code without refreshing itself.

VI. Method

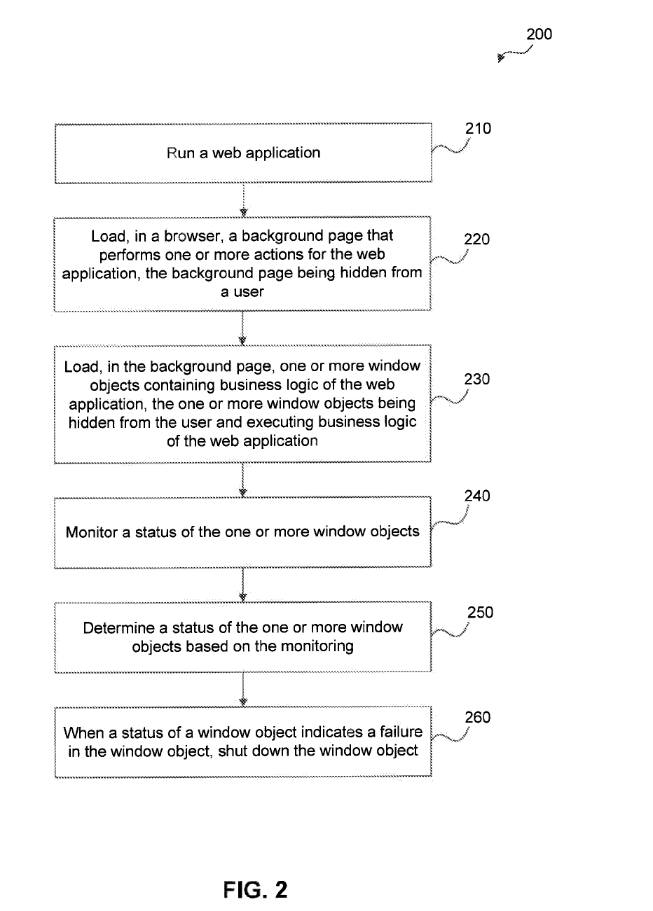

FIG. 2 is a flowchart illustrating a method 200 for monitoring a background page, according to an embodiment. Method 200 may be used, for example, in operation of system 100. At stage 210, a web application is run.

At stage 220, a background page that performs one or more actions for the web application is loaded in a browser. The background page may be hidden from a user.

At stage 230, one or more window objects containing business logic of the web application is loaded in the background page. The one or more window objects may be hidden from the user and may further execute business logic of the web application.

The window object may be dynamically loaded as a child node in the background page. In an embodiment, the background page is hard-coded to recognize which window objects the background page needs to load for each piece of business logic. In another embodiment, the background page exposes a mechanism to the foreground page to allow the foreground page to instruct the background page on what to load.

At stage 240, a status of the one or more window objects is monitored. The status of a window object may be monitored by a foreground page, a background page, or the window object.

At stage 250, a status of the one or more window objects is determined based on the monitoring at stage 240.

At stage 260, when a status of a window object indicates a failure in the window object, the window object is shut down. In one feature, the failure in the window object does not result in a failure of the web application.

In an embodiment, the web application operates only on the server. For example, a cloud application may be executed on one or more servers and connected to a network, and a user may access the cloud application via a browser. The cloud application may implement method 200 to monitor the background page associated with the cloud application.

In another embodiment, the web application operates only on the browser. For example, a client device (e.g., smart phone) may download an application. The downloaded application may run in a browser and implement method 200 to monitor the background page associated with the downloaded application.

In another embodiment, the functionality of the web application is split between the server and browser. For example, AJAX (asynchronous JavaScript and XML) separates the user interaction portion of an application from its server interaction. AJAX describes a range of technologies for developing responsive and dynamic web applications. A browser's object (e.g., XMLHttpRequest) may be used to perform asynchronous data exchanges with the web server. An application that uses AJAX technology may implement method 200 to monitor the background page associated with the application.

VII. Computer Embodiment

In an embodiment, the system and components of embodiments described herein are implemented using well known computers. For example, client 110 and server 115 may be implemented using system 300.

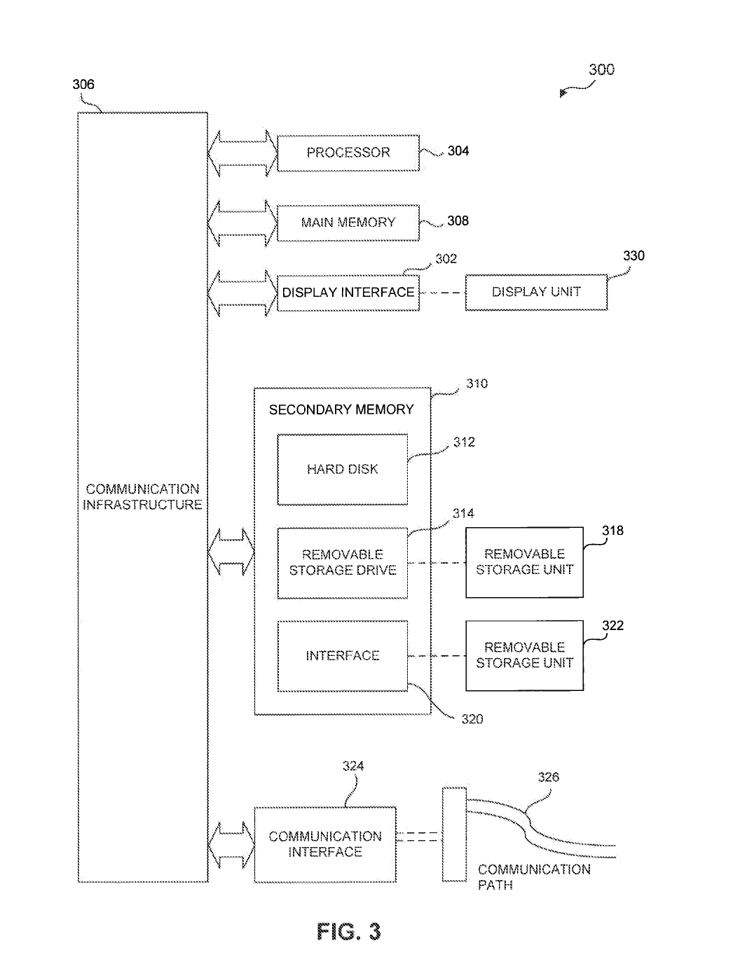

FIG. 3 illustrates an example computer system 300 in which embodiments may be implemented as computer-readable code. Hardware, software, or any combination of such may embody any of the modules and components in FIG. 1.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terms of this example computer system 300. After reading this description, it will become apparent to a person skilled in the relevant art how to implement embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 304 may be a special purpose or a general-purpose processor device. As will be appreciated by persons skilled in the relevant art, processor device 304 may also be a single processor in a multi-core/multiprocessor system, such system operating alone, or in a cluster of computing devices operating in a cluster or server farm. Processor device 304 is connected to a communication infrastructure 306, for example, a bus, message queue, network, or multi-core message-passing scheme. Computer system 300 may also include display interface 302 and display unit 330. Display interface 302 allows results of the computer operations to be displayed to a user or an application developer via display unit 330.

Computer system 300 also includes a main memory 308, for example, random access memory (RAM), and may also include a secondary memory 310. Secondary memory 310 may include, for example, a hard disk drive 312, removable storage drive 314. Removable storage drive 314 may include a floppy disk drive, a magnetic tape drive, an optical disk drive, a flash memory, or the like. The removable storage drive 314 reads from and/or writes to a removable storage unit 318 in a well-known manner. Removable storage unit 318 may include a floppy disk, magnetic tape, optical disk, etc. which is read by and written to by removable storage drive 314. As will be appreciated by persons skilled in the relevant art, removable storage unit 318 includes a computer usable storage medium having stored therein computer software and/or data.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Communications interface 324 may include a modem, a network interface (such as an Ethernet card), a communications port, a PCMCIA slot and card, or the like. Software and data transferred via communications interface 324 may be in the form of signals, which may be electronic, electromagnetic, optical, or other signals capable of being received by communications interface 324. These signals may be provided to communications interface 324 via a communications path 326, Communications path 326 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 318, removable storage unit 322, and a hard disk installed in hard disk drive 312. Computer program medium and computer usable medium may also refer to memories, such as main memory 308 and secondary memory 310, which may be memory semiconductors (e.g. DRAMs, etc.).

Computer programs (also called computer control logic) are stored in main memory 308 and/or secondary memory 310. Computer programs may also be received via communications interface 324. Such computer programs, when executed, enable computer system 300 to implement embodiments as discussed herein. In particular, the computer programs, when executed, enable processor device 304 to implement the processes, such as the stages in the method illustrated by flowchart 200 of FIG. 2 discussed above. Accordingly, such computer programs represent controllers of the computer system 300. Where embodiments are implemented using software, the software may be stored in a computer program product and loaded into computer system 300 using removable storage drive 314, interface 320, and hard disk drive 312, or communications interface 324.

Embodiments also may be directed to computer program products including software stored on any computer useable medium. Such software, when executed in one or more data processing device, causes a data processing device(s) to operate as described herein. Embodiments employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The Summary and Abstract sections may set forth one or more but not all exemplary embodiments as contemplated by the inventor(s), and thus, are not intended to limit the embodiments and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A computer-implemented method for monitoring a background page, comprising:
(a) running a web application;
(b) loading, in a browser, a background page that performs one or more actions for the web application, the background page being hidden from a user, wherein the web application launches the background page;
(c) loading, in the background page, one or more window objects containing business logic of the web application, the one or more window objects being hidden from the user and executing business logic of the web application;
(d) monitoring a status of the one or more window objects, wherein the monitoring includes determining whether a status function is available to the background page, wherein an unavailability of the status function indicates a failure of one or more of the window objects;
(e) determining a status of the one or more window objects based on the monitoring; and
(f) when a status of a window object indicates the failure in the window object, shutting down the window object,
whereby the failure in the window object does not result in a failure of the web application.

2. The method of claim 1, wherein the one or more window objects is an I-frame window object.

3. The method of claim 1, further including:
(g) executing a first script in the background page; and
(h) executing a second script, different from the first script, in a window object in the background page, the window object defining a function that is exposed to the first script,
wherein the monitoring (d) includes invoking the function at the first script.

4. The method of claim 1, further including:
(g) executing a first script in a foreground page, wherein the foreground page spawns the background page; and
(h) executing a second script, different from the first script, in the background page, the second script exposing a function to the first script, and the function being defined by a window object loaded in the background page,
wherein the monitoring (d) includes invoking the function at the first script.

5. The method of claim 1, wherein a window object executes a script, and
the determining (e) includes determining whether the script has successfully loaded.

6. The method of claim 1, further including:
(g) after shutting down the window object, reloading the window object in the background page.

7. The method of claim 1, wherein the loading (c) is based on monitoring cookies received from a server.

8. The method of claim 1, further including injecting the window object into a document object model of the background page.

9. The method of claim 8, wherein the window object is directly accessible to the web application via the document object model of the background page.

10. The method of claim 1, wherein the background page is served from a same domain as a foreground page.

11. The method of claim 1, wherein when the status of the window object satisfies one or more criteria, the status of the window object indicates the failure in the window object.

12. The method of claim 1, further including:
(g) executing a first script in the background page; and
(h) executing a second script, different from the first script, in a window object in the background page, the window object setting a variable that indicates a status of the window object,
wherein the monitoring (d) includes determining a value of the variable.

13. The method of claim 12, wherein the variable is stored in a local storage that is accessible to the background page and the window object.

14. The method of claim 1, further including:
(g) executing a first script in the background page; and
(h) executing a second script, different from the first script, in a window object in the background page, the second script sending a message to the first script that indicates a status of the window object,
wherein the monitoring (d) includes analyzing the message.

15. A system for monitoring a background page, comprising:
a browser, operating on a computer including at least one processor, coupled to a web application;
a background page loader, operating on the computer, configured to:
(i) load, in the browser, the background page that performs one or more actions for the web application, the background page being hidden from a user, wherein the web application launches the background page; and
(ii) load, in the background page, one or more window objects containing business logic of the web application, the one or more window objects being hidden from the user and executing business logic of the web application; and
a monitor, operating on the computer, configured to:
(i) monitor a status of the one or more window objects and determine whether a status function is available to the background page, wherein an unavailability of the status function indicates a failure of one or more of the window objects;
(ii) determine a status of the one or more window objects based on the monitoring; and
(iii) when a status of a window object indicates the failure in the window object, shut down the window object,
whereby the failure in the window object does not result in a failure of the web application.

16. The system of claim 15, wherein the one or more window objects is an I-frame window object.

17. The system of claim 15, wherein
a window object is configured to define a function and execute a script, and
the background page is configured to invoke the function and is further configured to determine whether the script has successfully loaded based on invoking the function.

18. The system of claim 15, wherein
a window object defines a function, and
the monitor is a foreground page configured to:
(i) obtain, via the background page, a reference to the function,
(ii) invoke the function defined by the window object, and
(iii) determine a status of the window object based on the invoked function.

19. The system of claim 15, wherein the background page is served from a same domain as a foreground page.

20. The system of claim 15, wherein the background page is configured to when the status of the window object satisfies one or more criteria, reload the window object in the background page.

21. A non-transitory computer readable storage medium encoded with a computer program, the program comprising instructions that when executed by one or more processors cause the one or more processors to perform operations to:
run a web application;
load, in a browser, a background page that performs one or more actions for the web application, the background page being hidden from a user, wherein the web application launches the background page;
load, in the background page, one or more window objects containing business logic of the web application, the one or more window objects being hidden from the user and executing business logic of the web application;
monitor a status of the one or more window objects and determine whether a status function is available to the background page, wherein an unavailability of the status function indicates a failure of one or more of the window objects;
determine a status of the one or more window objects based on the monitoring; and
when a status of a window object indicates the failure in the window object, shut down the window object,
whereby the failure in the window object does not result in a failure of the web application.

22. The computer readable storage medium of claim 21, wherein the one or more window objects is an I-frame window object.

23. The computer readable storage medium of claim 21, wherein the instructions that when executed by one or more processors further cause the one or more processors to perform operations to:
execute a first script in the background page; and
execute a second script, different from the first script, in a window object in the background page, the window object defining a function that is exposed to the first script,
wherein the instructions that when executed by one or more processors cause the one or more processors to perform operations to monitor a status of the one or more window objects include instructions that when executed by one or more processors further cause the one or more processors to perform operations to invoke the function at the first script.

24. The computer readable storage medium of claim 21, wherein the instructions that when executed by one or more processors further cause the one or more processors to perform operations to:
execute a first script in a foreground page that spawns the background page; and
execute a second script, different from the first script, in the background page, the second script exposing a function to the first script, and the function being defined by a window object loaded in the background page,
wherein the instructions that when executed by one or more processors cause the one or more processors to perform operations to monitor a status of the one or more window objects include instructions that when executed by one or more processors further cause the one or more processors to perform operations to invoke the function at the first script.

25. The method of claim 1, wherein an availability of the status function indicates that a particular one of the window objects successfully loaded.

26. The method of claim 1, wherein the determining further comprises: periodically calling, by the background page, the status function to determine the status of the window objects.

27. The method of claim 25, further comprising: receiving a value from the called status function, wherein the received value indicates a health of the window object.

28. The method of claim 1, wherein the unavailability of the status function indicates that one or more of the window objects have failed to load.
